(19) United States
(12) Patent Application Publication
(10) Pub. No.: US 2026/0159729 A1
(43) Pub. Date: Jun. 11, 2026

(54) HIGHLY WEATHERABLE PROTECTIVE FILM FOR EXTERIOR WINDOW OR PAINTING SURFACE

(71) Applicant: E and B Co., Ltd., Yeongdong-gun (KR)

(72) Inventor: Tae Sung LEE, Daejeon (KR)

(73) Assignee: E and B Co., Ltd., Yeongdong-gun (KR)

(21) Appl. No.: 19/395,647

(22) Filed: Nov. 20, 2025

(30) Foreign Application Priority Data
Dec. 11, 2024 (KR) 10-2024-0184023

(51) Int. Cl. C09J 7/29

(52) U.S. Cl. CPC C09J 7/29; C09J 2203/346; C09J 2301/162; C09J 2301/41; C09J 2475/001

(57) ABSTRACT

A highly weatherable protective film for an exterior window or painting surface, includes a functional flexible film as a base layer. The functional flexible film includes a thermosetting, water-based, non-yellowing polyurethane emulsion composition and a functional additive. The functional additive is one or more of a water-dispersed dye or pigment having a size of 10 to 300 nm for ensuring visible light transmittance, a pigment having a size of 10 μm or more for ensuring visible light non-transmittance, one or more metal oxides selected from cerium tin oxide (CTO), antimony tin oxide (ATO), indium tin oxide (ITO), and WO₃ having heat-blocking properties, a ultraviolet ray (UV) blocker for blocking UV, a UV stabilizer for ensuring stability against UV, and an infrared ray (IR) blocker for blocking IR.

### CROSS-REFERENCE TO PRIOR APPLICATION

This Application claims priority to Korean Patent Application No. 10-2024-0184023 (filed on Dec. 11, 2024), which is hereby incorporated by reference in its entirety.

### BACKGROUND

The present invention relates to a protective film, and more specifically, to a highly weatherable protective film for an exterior window or painting surface that has excellent durability and weatherability, is capable of effectively protecting an exterior window or painting layer, and may be applied to a curved surface without thermoforming, thereby providing excellent workability.

A protective film for an exterior window or painting surface is generally composed of a base layer made of a plastic film such as polyethylene terephthalate (PET), poly(methyl methacrylate) (PMMA), and polycarbonate (PC); a hard coating layer formed on a upper surface of the base layer; and an adhesive layer formed on an lower surface of the base layer.

In particular, protective films containing a PET substrate layer offer superior transparency, ensuring excellent visibility. They also possess superior impact resistance and durability compared to other plastic films, making them the most commonly used protective films for exterior windows.

However, these conventional protective films require a thermal forming process, such as applying heat (e.g., hot air) to curved portions of glass or painted surfaces, making the process extremely time-consuming. Furthermore, because both the base layer and coating layers are rigid, these protective films offer limited impact absorption. When used on windshields of automobiles, this limits their ability to absorb impact from flying stones or other hazardous materials, making them ineffective in preventing windshield damage.

Furthermore, conventional protective films incorporate various functional materials into the hard coating layer, such as UV blocking, infrared absorbing, or heat blocking materials, to provide functionality. However, these films are susceptible to degradation of the hard coating layer's properties due to external environmental factors such as temperature and humidity, leading to exfoliation from the base layer or deformation.

### RELATED ART

KR 10-2022-0013531 A
KR 10-2381911 B1

### SUMMARY

Accordingly, an object of the present invention is to provide a highly weatherable protective film for an exterior window or painting surface that does not deteriorate in physical properties due to the influence of the external environment, has excellent adhesion and bonding between a base layer and a surface coating layer, and has excellent durability and weatherability so that physical properties can be preserved for a long time by including a functional flexible film composed of a thermosetting water-based non-yellowing polyurethane emulsion composition and a functional additive as a base layer.

Another object of the present invention is to provide a highly weatherable protective film for an exterior window or painting surface that further improves bonding, durability, and weatherability with a surface coating layer by including a hybrid film combining a functional flexible film and a support as a base layer.

Still another object of the present invention is to provide a highly weatherable protective film for an exterior window or painting surface that can be applied to curved portions of glass or a painting layer without a thermoforming process, thereby improving workability.

To achieve the above-described objects, the present invention provides a highly weatherable protective film for an exterior window or painting surface, the film comprising a functional flexible film as a base layer including a thermosetting, water-based, non-yellowing polyurethane emulsion composition and a functional additive, wherein the functional additive is one or more of: a water-dispersed dye or pigment having a size of 10 to 300 nm for ensuring visible light transmittance; a pigment having a size of 10 μm or more for ensuring visible light non-transmittance; one or more metal oxides selected from cerium tin oxide (CTO), antimony tin oxide (ATO), indium tin oxide (ITO), and WO₃ having heat-blocking properties; a ultraviolet ray (UV) blocker for blocking UV; a UV stabilizer for ensuring stability against UV; and an infrared ray (IR) blocker for blocking IR.

The thermosetting, water-based, non-yellowing polyurethane emulsion composition is a two-liquid composition, a main agent including 100 parts by weight of a polyurethane emulsion, 50 to 69 parts by weight of pentyl acetate, 40 to 59 parts by weight of 1-pentanol, 50 to 70 parts by weight of 3,5-dinitrobenzoyl chloride, and 40 to 60 parts by weight of cyclohexyl 3,5-dinitrobenzoate, and a curing agent including 100 parts by weight of 2-methyl-1-aziridinepropionate, 30 to 50 parts by weight of pentylmagnesium bromide, 20 to 40 parts by weight of triphenylmethanol, and 31 to 40 parts by weight of 2-heptanone.

The main agent and the curing agent are mixed in a volume ratio of 100:1 to 10 to adjust the Shore A Hardness value of the functional flexible film to 30 to 99.

The protective film is attachable on a curved portion without heat forming.

The base layer has a thickness of 1 to 400 μm, and when the thickness is 200 to 400 μm, the base layer is formed by thermally laminating two or more functional flexible films.

The base layer further includes a support bonded to a lower surface of the functional flexible film, and the support is a plastic film, a deposited plastic film, or a sputtered plastic film.

The base layer is formed by laminating two or more hybrid films in which a support and a functional flexible film are combined.

The support is any one of polyethylene terephthalate (PET) film, polyvinylchloride (PVC) film, poly(methyl methacrylate) (PMMA) film, polyurethane (PU) film, thermoplastic polyurethane (TPU) film, or elastic polyurethane (EPU) film, the support has a thickness of 10 to 200 μm, and the functional flexible film has a thickness of is 1 to 400 μm.

The two or more hybrid films are laminated by thermal lamination or using a urethane adhesive or an acrylic adhesive, and the urethane adhesive or the acrylic adhesive includes one or more of: one or more metal oxides having heat-insulating properties, such as CTO, ATO, ITO, and WO₃; a UV blocker for blocking ultraviolet rays; a UV stabilizer for ensuring stability from UV; and an IR blocker for blocking IR.

The highly weatherable protective film for the exterior window or painting surface further includes a self-recovery layer additionally formed on an upper surface of the base layer, and the self-recovery layer is composed of a polyester-polyurethane hybrid resin, obtained by mixing a polyurethane acrylic prepolymer and a polyester prepolymer, and a curing agent.

### BRIEF DESCRIPTION OF THE DRAWINGS

FIG. 1 is a cross-sectional view illustrating a protective film according to one embodiment of the present invention.

FIG. 2 is a cross-sectional view illustrating a protective film according to one embodiment of the present invention.

### DETAILED DESCRIPTION

Hereinafter, the present invention will be described in more details.

The protective film according to the present invention is applied not only to exterior windows of buildings, but also to exterior windows of automobiles, and painting surfaces, and the like to repel water, prevent stain, and protect from UV, IR, visible light, and the like.

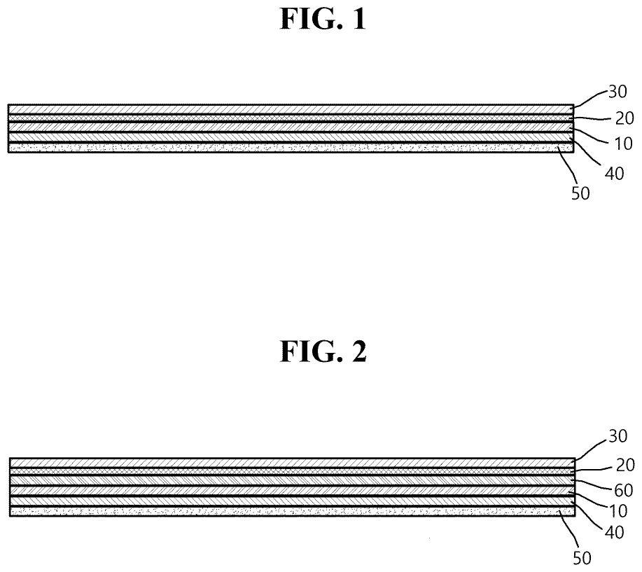

The highly weatherable protective film for the exterior window or painting surface according to the present invention includes, as shown in FIG. 1, a base layer 10, a surface coating layer 20 formed on an upper surface of the base layer 10, a protective film layer 30 formed on an upper surface of the surface coating layer 20 to protect the surface coating layer 20, an adhesive layer 40 formed on a lower surface of the base layer 10, and a release layer 50 provided on a lower surface of the adhesive layer 40 to protect the adhesive layer 40, but the surface coating layer 20 may be omitted as needed.

In other words, the feature of the protective film according to the present invention is the base layer 10, and the surface coating layer 20, protective film layer 30, adhesive layer 40, and release layer 50 are based on a known protective film for glass.

The most significant feature of the present invention is that the base layer 10 includes a functional flexible film having excellent adhesion, durability, and weatherability, thereby preserving properties for a long period of time. In other words, through this functional flexible film, the present invention increases the adhesion and binding between the surface coating layer 20 and the base layer 10, improves the durability and weatherability of the protective film, improve shock absorption, and also improve workability to enable attachment on a curved portion without thermoforming.

More specifically, the base layer 10 of the present invention may solely include a functional flexible film, or may include a support laminated thereto.

First, the functional flexible film of the present invention will be described.

The functional flexible film includes a water-based, non-yellowing polyurethane emulsion composition and a functional additive.

The thermosetting, water-based, non-yellowing polyurethane emulsion composition not only exhibits excellent yellowing resistance, stain resistance, and durability, but also excellent elongation, resilience, and elasticity by forming a urethane bond. Furthermore, it exhibits excellent adhesive properties, thereby improving adhesion and bonding with a surface coating layer 20 formed on the upper surface.

The thermosetting, water-based, non-yellowing polyurethane emulsion composition is a two-liquid composition. A main agent includes 100 parts by weight of a polyurethane emulsion, 50 to 69 parts by weight of pentyl acetate, 40 to 59 parts by weight of 1-pentanol, 50 to 70 parts by weight of 3,5-dinitrobenzoyl chloride, and 40 to 60 parts by weight of cyclohexyl 3,5-dinitrobenzoate, and a curing agent includes 100 parts by weight of 2-methyl-1-aziridinepropionate, 30 to 50 parts by weight of pentylmagnesium bromide, 20 to 40 parts by weight of triphenylmethanol, and 31 to 40 parts by weight of 2-heptanone. At this time, the ‘part by weight’ of the main agent is based on 100 parts by weight of the polyurethane emulsion, and the ‘part by weight’ of the curing agent is based on 100 parts by weight of the 2-methyl-1-aziridine propionate.

The polyurethane emulsion, which is the main ingredient included in the main agent, provides functions such as elongation, resilience, and adhesion, and a mixture of 2-methyl-1,5-pentamethylene diisocyanate and 1,12-dodecane diisocyanate in a volume ratio of 8:1 to 3 is preferably used in consideration of the adhesiveness, flexibility, and the like of the flexible film. In addition, the pentyl acetate provides coating functionality, 1-pentanol and 3,5-dinitrobenzoyl chloride are for adjusting the viscosity, and cyclohexyl 3,5-dinitrobenzoate is for improving the adhesiveness. When the mixing ratio in the main agent deviates from the above-described range, the overall physical properties deteriorate, and therefore, the polyurethane emulsion is preferably formed in the above-described mixing ratio.

In addition, the curing agent, which includes 2-methyl-1-aziridinepropionate, pentylmagnesium bromide, triphenylmethanol, and 2-heptanone, forms a film through reaction with the main agent, thereby improving the physical properties such as excellent shock resistance, durability, self-leveling properties, and heat and aging resistance. In addition, since sufficient physical properties are difficult to secure when the mixing ratio deviates from the above-described range, the curing agent is preferably formed in the above-described mixing ratio.

In addition, in the present invention, the main agent and the curing agent are preferably mixed in a volume ratio of 100:1 to 10, and by controlling the mixing ratio of the main agent and the curing agent within the above-described range, the Shore hardness value of the functional flexible film is controlled. In other words, the less the amount of the curing agent used, the lower the Shore A Hardness value, and the more the amount, the higher the Shore A Hardness value, and when the mixing ratio deviates from the above-described range, film formation is difficult. The Shore A Hardness value may be controlled within the range of 30 to 99.

Here, the functional additive is one or more of: a water-dispersed dye or pigment having a size of 10 to 300 nm for ensuring visible light transmittance; a pigment having a size of 10 μm or more for ensuring visible light non-transmittance; one or more metal oxides selected from cerium tin oxide (CTO), antimony tin oxide (ATO), indium tin oxide (ITO), and WO₃ having heat-blocking properties; a ultraviolet ray (UV) blocker for blocking UV; a UV stabilizer for ensuring stability against UV; and an infrared ray (IR) blocker for blocking IR, and most preferably, all six of the functional additives are used. At this time, it is obvious that all of the functional additives may be used in a state of being dispersed in water or in a separate solvent.

In the present invention, since the functional additive is included in a functional flexible film used as a base layer 10 rather than a surface coating layer 20 exposed to the outside, the physical properties are not easily deteriorated by external environmental factors such as temperature, humidity, and UV, resulting in excellent durability and weatherability. Furthermore, even without forming a separate surface coating layer 20, excellent functionality, durability, and weatherability can be realized with only the base layer 10, so that the surface coating layer 20 may be omitted.

Here, the type of dye or pigment may be one known in the field to which this technology belongs, and the UV blocker, UV stabilizer, and IR blocker may also be general materials known in this field, and therefore, further description thereof will be omitted.

However, based on 100 parts by weight of the polyurethane emulsion in the main agent of the above-described water-based, non-yellowing polyurethane emulsion composition, it is preferable to use the water-dispersed dye or pigment having a size of 10 to 300 nm for ensuring visible light transmittance in an amount of 1 to 10 parts by weight; the pigment having a size of 10 μm or more for ensuring visible light non-transmittance in an amount of 1 to 10 parts by weight; one or more metal oxides selected from CTO, ATO, ITO, and WO₃ having heat-blocking properties in an amount of 5 to 50 parts by weight; a ultraviolet ray (UV) blocker for blocking UV in an amount of 1 to 10 parts by weight; a UV stabilizer for ensuring stability against UV in an amount of 1 to 10 parts by weight; and an infrared ray (IR) blocker for blocking IR in an amount of 1 to 10 parts by weight.

A method for manufacturing the functional flexible film is based on the conventional technology. A thermosetting, water-based, non-yellowing polyurethane emulsion composition is mixed with a functional additive. The viscosity is adjusted to 50 to 300 cps by mixing water, isopropyl alcohol (IPA), or other additives. The film may then be manufactured using a thermosetting coating method such as slot die, microgravure, or comma coating.

Furthermore, the water-based, non-yellowing polyurethane emulsion composition may further include known additives, such as antioxidants, without limitation.

In this case, the thickness is preferably 10 to 200 μm. However, when forming a functional flexible film with a thickness of 200 μm or more, there is a disadvantage in that transparency is reduced when a heat-curing coating method is used. Therefore, when the thickness is to be 200 μm or more, the thickness may be controlled by manufacturing two or more functional flexible films by a heat-curing coating method, and then applying heat of about 100° C. to them to thermally laminate them and integrate them. According to this thermal laminating method, even when the thickness becomes 200 μm or more, transparency is not reduced, and the thermally laminated portion does not exfoliate by an external force due to the strong bonding force.

The above-described functional flexible film of the present invention exhibits superior strength, transparency, adhesion, resilience, elongation, tensile strength, and abrasion resistance, and is easy to process. Furthermore, the flexible film exhibits excellent adhesion and cohesiveness without the need for separate corona treatment or primer treatment.

When the base layer 10 consists solely of the functional flexible film, it can be applied to a curved portion without separate thermoforming, significantly enhancing the workability.

In addition, in the present invention, the base layer 10 may be a hybrid film in which a support is laminated to a lower surface of the functional flexible film. This means that the support further enhances the strength while also improving durability, weatherability, and abrasion resistance.

In this case, the support may be a commonly used plastic film such as polyethylene terephthalate (PET) film or poly(methyl methacrylate) (PMMA) film, as well as a polyurethane plastic film. This is because these supports have excellent physical properties, are easy to process, and are readily available. Furthermore, when necessary, a metal-deposited plastic film or a metal-sputtered plastic film may be used. This is because using such a film can improve heat reflection performance without a separate metal coating. However, considering processability, physical properties, and price, the use of a PET film as the support is most preferred.

In other words, when using only a conventional plastic film as a base layer 10, functional materials had to be mixed and used in the surface coating layer 30 and the adhesive layer 40, and thus overall film properties were not maintained for a long time, and due to the poor adhesion, durability and weatherability were poor. However, in the present invention, since the base layer 10 has such functions, there is no need to use functional materials in the surface coating layer 30 and the adhesive layer 40, and therefore, the durability and weatherability of the protective film are improved. However, it is obvious that a small amount of functional materials may be added to the surface coating layer 30 and the adhesive layer 40 in order to realize better initial heat-insulating properties, and the like, and this additional implementation is not limited.

In this case, when the base layer 10 is composed of a hybrid film including a support, thermoforming is required due to the support, the protective film is difficult to apply to painting surfaces and may be applied to only glass. However, the hybrid film formed with a thinner support than conventional plastic films and includes a functional flexible film, significantly shortening the thermoforming process and improving workability.

Therefore, in the present invention, the support has a thickness of 12 to 188 μm. When the thickness is less than 12 μm, thermal shrinkage and deformation make it difficult to serve as a support, while when the thickness exceeds 100 μm, excessive thermoforming is required. Furthermore, as previously described, the hybrid film preferably has a thickness of 10 to 200 μm.

In the present invention, the hybrid film may be manufactured by coating a thermosetting, water-based, non-yellowing polyurethane emulsion composition containing a functional additive on a support. For ease of coating, water may be added to the thermosetting, water-based, non-yellowing polyurethane emulsion composition containing the functional additive. In addition, it is also possible to add a small amount of IPA, alcohol, or the like to maintain the viscosity of the emulsion composition. The emulsion composition preferably has a viscosity of 80 to 150 cps in consideration of the physical properties, smoothness, workability, and the like of the formed film layer.

In addition, the base layer 10 of the present invention may be formed by laminating a plurality of the hybrid films.

In this case, the hybrid films may be laminated by thermal lamination or using a urethane adhesive or an acrylic adhesive. When the urethane adhesive is used, the urethane adhesive may include one or more of: one or more metal oxides having heat-insulating properties, such as CTO, ATO, ITO, and WO₃; a UV blocker for blocking ultraviolet rays; a UV stabilizer for ensuring stability from UV; and an IR blocker for blocking IR in order to perform lamination.

Based on 100 parts by weight of the urethane adhesive, the metal oxide may be used in an amount of 1 to 10 parts by weight, the UV blocker may be used in an amount of 1 to 10 parts by weight, the UV stabilizer may be used in an amount of 1 to 10 parts by weight, and the IR blocker may be used in an amount of 1 to 10 parts by weight.

When the hybrid film according to the present invention is used as a base layer 10, damage caused by fragments can be reduced due to the elasticity and restoration function of the flexible film when the glass is broken, and stress caused by an external force can be significantly alleviated through the interaction between the flexible film and the support, thereby preventing breakage of the glass caused by an external force.

Meanwhile, as shown in FIG. 2, it is more preferable that the protective film of the present invention additionally forms a self-recovery layer 60 on an upper surface of the support.

The self-recovery layer protects the base layer 10 from external impacts or foreign substances and preferably has a thickness of 10 to 20 μm.

The self-recovery layer has strong adhesion to the underlying base layer 10, that is, the hybrid film layer, and thus is not easily detached due to external environmental factors. The self-recovery layer can also repair scratches and improve impact resistance.

The self-recovery layer 60, when used in combination with a hybrid film, significantly improves durability and weatherability through their interaction. This is because the hybrid film containing a water-based polyurethane material and the self-recovery layer 60 containing a urethane acrylic resin have high mutual bonding strength, thereby increasing durability. In addition, the hybrid film and the self-recovery layer 60, which have elasticity and self-recovery properties, more effectively restore pressure marks and scratches caused by external environmental factors, through their interaction.

In this case, the self-recovery layer 60 is composed of a polyester-polyurethane hybrid resin, obtained by mixing a polyurethane acrylic prepolymer and a polyester prepolymer, and a curing agent.

In this case, one selected from cyclohexane diisocyanate, isophorone diisocyanate, hexamethylene diisocyanate, or a combination thereof is allowed to react with trimethylene oxide, neopentyl glycol, 1,6-hexanediol, trimethylol glycol, ethylene propylene block polyol, and the like to prepare a polyurethane prepolymer having a hydroxyl group at the terminal, and adipic acid, sebacic acid, maleic acid, or chitosan is allowed to react with an ethylene-propylene block polyol to prepare a polyester prepolymer having a hydroxyl group exists at the terminal. Thereafter, the prepared polyurethane prepolymer is mixed with the prepared polyester prepolymer in a ratio of 100:20 to 60 parts by weight to produce a polyurethane-polyester hybrid resin. At this time, it is obvious that additives such as dispersants, leveling agents, and viscosity modifiers may be further mixed to improve physical properties as needed.

In addition, a known isocyanate curing agent is mixed with the polyester-polyurethane hybrid resin, and the resulting mixture is applied to the flexible film layer and then cured to form a self-recovery layer 60.

In this case, the mixing ratio of each component is described in the examples below.

Meanwhile, the surface coating layer 20, the protective film layer 30, the adhesive layer 40, and the release film 50 of the present invention have the same composition as the known protective film for glass as described above, and thus further description thereof will be omitted. However, in the present invention, since the base layer 10 includes a functional material having heat-insulating properties, UV-blocking properties, and the like, there is no need to mix separate functional additives into the surface coating layer 20 and the adhesive layer 40, and when even better heat-insulating properties, and the like are required, the functional additives may be appropriately mixed within the previously disclosed mixing ratio.

For example, the surface coating layer 20 may be formed of a urethane resin layer containing a urethane resin and an isocyanate curing agent, and the protective film layer 30 may be formed of a PET film. In this case, it is obvious that the protective film layer 30 and the release layer 50 are removed after or during construction.

Hereinafter, the present invention will be described in more detail through specific examples.

### Example 1

The main agent was prepared by adding 1,000 g of polyurethane emulsion, 650 g of pentyl acetate, 500 g of 1-pentanol, 600 g of 3,5-dinitrobenzoyl chloride, and 500 g of cyclohexyl 3,5-dinitrobenzoate, and then dispersing at −3° C. and 10,000 rpm for two hours.

The curing agent was then prepared by mixing 1,000 g of 2-methyl-1-aziridinepropionate with 400 g of pentylmagnesium bromide, 300 g of triphenylmethanol, and 350 g of 2-heptanone.

Next, the main agent and the curing agent were mixed in a volume ratio of 100:1, and 100 g of a water-dispersed pigment having a size of 10 to 300 nm, 10 g of a pigment having a size of 10 μm or larger, 100 g of ITO, 50 g of a UV blocker, 50 g of a UV stabilizer, and 50 g of an IR blocker for IR protection were added as functional additives.

This mixture was then formed into a 100 μm-thick film using a thermal curing coating method.

### Example 2

The same procedure as Example 1 was followed, except that the main agent and the curing agent were used in a volume ratio of 100:5.

### Example 3

The same procedure as Example 1 was followed, except that the main agent and the curing agent were used in a volume ratio of 100:10.

### Test Example 1

The hardness A values of Examples 1 to 3 were measured according to the ASTM D 2240 method.

TABLE 1
Results of Test Example 1

| Classification | Example 1 | Example 2 | Example 3 |
|---|---|---|---|
| Shore A | 35 | 66 | 91 |
| hardness | | | |

As shown in Table 1, it was confirmed that the hardness A value may be controlled through the mixing ratio of the main agent and the curing agent.

### Example 4

A base layer was prepared by applying the composition of Example 2 to a thickness of 100 μm on an upper surface of a 50 μm PET substrate and thermally curing the applied composition. A surface coating layer containing 100 parts by weight of a urethane resin and 40 parts by weight of an isocyanate curing agent was formed on an upper surface of the base layer to a thickness of 15 μm.

In addition, an adhesive layer containing 85 parts by weight of an acrylic copolymer, 0.8 parts by weight of a curing agent, and 35 parts by weight of a solvent was formed to a thickness of 10 μm on a lower surface of the base layer, and a release layer was laminated thereto.

### Example 5

The same procedure as Example 4 was followed, except that a self-recovery layer was formed on an upper surface of the base layer to a thickness of 20 μm.

In this case, the self-recovery layer was formed as described below.

50 g of cyclohexane diisocyanate, 150 g of isophorone diisocyanate, 11 g of trimethylene oxide, 42 g of 1,6-hexanediol, and 20 g of neopentyl glycol were placed in a 120 g xylene reactor and stirred for eight hours under a nitrogen atmosphere while maintaining the temperature at 80° C. to prepare a polyurethane prepolymer having a urethane structure in the molecule, and hydroxyl groups at the terminals with a hydroxyl value of 60 mgKOH/g. In addition, adipic acid (40 g), maleic anhydride (15 g), chitosan (20 g), 1,6-hexanediol (21 g), and neopentyl glycol (50 g) were added to the reactor and stirred for one hour while maintaining the temperature at 140° C. Thereafter, the reactor temperature was raised to 200° C. and maintained for a reaction until the acid value remained below 5. Then, the reactor was cooled to 60° C., and a xylene solvent was added to maintain a solid content of 50%.

Next, the polyurethane prepolymer was added and stirred in the reactor for approximately one hour to produce a hybrid polyester-polyurethane resin. An isocyanate curing agent was then mixed with this resin in a weight ratio of 10:4, and the resulting mixture was applied to the substrate film and cured for 60 minutes to form a self-recovery layer.

### Comparative Example 1

A base layer including a 50 μm PET film was formed, and a surface coating layer including 100 parts by weight of a urethane resin and 40 parts by weight of an isocyanate curing agent was formed to a thickness of 15 μm on an upper surface of the base layer. In addition, an adhesive layer including 85 parts by weight of an acrylic copolymer, 0.8 parts by weight of a curing agent, and 35 parts by weight of a solvent was formed to a thickness of 10 μm on a lower surface of the base layer, and a release layer was laminated thereto to produce a protective film. At this time, the same functional additives as in Example 4 were mixed in the same amount in the surface coating layer.

### Test Example 2

The UV blocking rate and the IR blocking rate of Example 4 and Comparative Example 1 were tested using a portable solar spectrometer, and the results are shown in Table 2 below.

TABLE 2
Results of Test Example 2

| | UV blocking rate (%)/IR |
|---|---|
| Classification | blocking rate (%) |
| Example 4 | 100/85.9 |
| Comparative Example 1 | 100/84.5 |

As shown in Table 2, it was confirmed that Example 4 exhibited excellent UV blocking rate and IR blocking rate at a similar level to Comparative Example 1.

### Test Example 3

Example 4 and Comparative Example 1 were tested for weatherability by irradiating them with UV light at a dose of approximately 1,000 mJ/cm² for five hours.

Comparative Example 1 showed rapid surface aging due to continuous exposure to UV light, and the film was damaged, resulting in exfoliation of film layers due to cracks caused by aging.

On the other hand, Example 4 showed slight color change, but no damage or breakage to the film itself occurred.

TABLE 3
Results of Test Example 3

| Classification | Δb* |
|---|---|
| Example 4 | 0.51 |
| Comparative Example 1 | 1.54 |

As described in Table 3, Example 4 exhibited superior yellowing characteristics and durability compared to Comparative Example 1 and also show superior weatherability.

### Test Example 4

The scratch resistance of Examples 4 and 5 and Comparative Example 1 was tested.

The scratch resistance was assessed using a wear tester under conditions of 500 g and 20 rpm in 100 reciprocating cycles by examining the occurrence of scratches on the film surface.

As a result, Example 4 recovered slightly after scratching, but showed differences compared to the initial product. Example 5 recovered to a level similar to the initial product after scratching. Comparative Example 1 showed scratches with no recovery.

The highly weatherable protective film for the exterior window or painting surface of the present invention, by imparting functionality to the base layer rather than the surface coating layer or adhesive layer, has deterioration of the physical properties due to the influence of the external environment, has excellent durability and weatherability, and maintains the physical properties of the protective film for a long time. Furthermore, the protective film has excellent adhesion and bonding with the protected surface layer due to the base layer having flexibility, elasticity, resilience, adhesiveness, and the like, and has the advantage of excellent workability because it can be applied to a curved portion without a thermoforming process.

The description of the disclosed embodiments is provided to enable any person skilled in the art to use or implement the present invention. Various modifications to these embodiments will be readily apparent to those skilled in the art, and the general principles defined herein may be applied to other embodiments without departing from the scope of the present invention. Therefore, the present invention is not limited to the embodiments disclosed herein, but is to be construed in the broadest scope consistent with the principles and novel features disclosed herein.

[Reference numerals]

| | |
|---|---|
| 10: Base layer | 20: Surface coating layer |
| 30: Protective film layer | 40: Adhesive layer |
| 50: Release layer | |

1. A highly weatherable protective film for an exterior window or painting surface, the film comprising a functional flexible film as a base layer including a thermosetting, water-based, non-yellowing polyurethane emulsion composition and a functional additive,
wherein the functional additive is one or more of:
a water-dispersed dye or pigment having a size of 10 to 300 nm for ensuring visible light transmittance;
a pigment having a size of 10 μm or more for ensuring visible light non-transmittance;
one or more metal oxides selected from cerium tin oxide (CTO), antimony tin oxide (ATO), indium tin oxide (ITO), and WO₃ having heat-blocking properties;
a ultraviolet ray (UV) blocker for blocking UV;
a UV stabilizer for ensuring stability against UV; and
an infrared ray (IR) blocker for blocking IR.

2. The highly weatherable protective film for the exterior window or painting surface of claim 1, wherein the thermosetting, water-based, non-yellowing polyurethane emulsion composition is a two-liquid composition, a main agent including 100 parts by weight of a polyurethane emulsion, 50 to 69 parts by weight of pentyl acetate, 40 to 59 parts by weight of 1-pentanol, 50 to 70 parts by weight of 3,5-dinitrobenzoyl chloride, and 40 to 60 parts by weight of cyclohexyl 3,5-dinitrobenzoate, and a curing agent including 100 parts by weight of 2-methyl-1-aziridinepropionate, 30 to 50 parts by weight of pentylmagnesium bromide, 20 to 40 parts by weight of triphenylmethanol, and 31 to 40 parts by weight of 2-heptanone.

3. The highly weatherable protective film for the exterior window or painting surface of claim 1, wherein the protective film is attachable on a curved portion without heat forming.

4. The highly weatherable protective film for the exterior window or painting surface of claim 1, wherein the base layer has a thickness of 1 to 400 μm, and when the thickness is 200 to 400 μm, the base layer is formed by thermally laminating two or more functional flexible films.

5. The highly weatherable protective film for the exterior window or painting surface of claim 4, wherein the support is any one of polyethylene terephthalate (PET) film, polyvinylchloride (PVC) film, poly(methyl methacrylate) (PMMA) film, polyurethane (PU) film, thermoplastic polyurethane (TPU) film, or elastic polyurethane (EPU) film, the support has a thickness of 10 to 200 μm, and the functional flexible film has a thickness of is 1 to 400 μm.

6. The highly weatherable protective film for the exterior window or painting surface of claim 1, further comprising a self-recovery layer additionally formed on an upper surface of the base layer, wherein the self-recovery layer is composed of a polyester-polyurethane hybrid resin, obtained by mixing a polyurethane acrylic prepolymer and a polyester prepolymer, and a curing agent.
